(19) United States
(12) Patent Application Publication
(10) Pub. No.: US 2009/0025947 A1
(43) Pub. Date: Jan. 29, 2009

(54) Method, arrangement and valve for controlling rock drilling

(76) Inventor: Vesa Peltonen, Tampere (FI)

Correspondence Address: DRINKER BIDDLE & REATH (DC), 1500 K STREET, N.W., SUITE 1100, WASHINGTON, DC, 20005-1209, US

(21) Appl. No.: 11/918,404

(22) PCT Filed: Apr. 11, 2006
(86) PCT No.: PCT/FI2006/050137

§ 371 Date: Oct. 12, 2007

(30) Foreign Application Priority Data
Apr. 15, 2005 (FI) 20055178

(51) Int. Cl. E21B 44/06

(52) U.S. Cl. 173/8; 173/1; 173/9; 137/625.2; 137/511

(57) ABSTRACT

A method, arrangement and valve for controlling rock drilling. In the method, a pressure difference acting across a rotation motor is used to regulate a separate feed regulating valve, which, on the basis of this, regulates control pressures of a feed control valve. The arrangement comprises a separate feed regulating valve, which, under the influence of the pressure difference acting across the rotation motor, regulates control pressures of a feed control valve. The valve comprises a separate retarding element, which slows down the returning of a spool of the valve to the normal position, if the spool has moved away from its normal position under the influence of the pressure difference acting across the rotation motor.

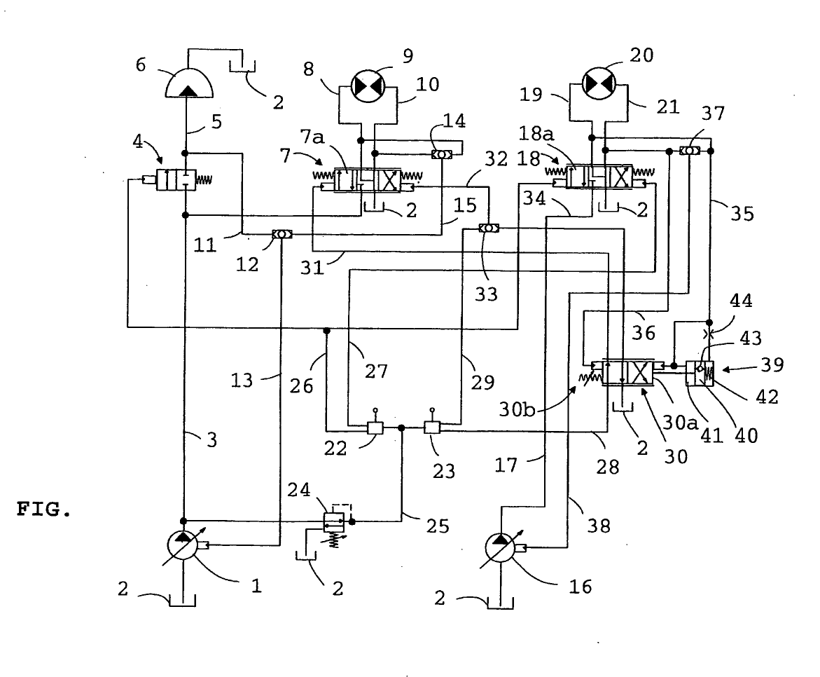

### BACKGROUND OF THE INVENTION

The invention relates to a method for controlling rock drilling, the method comprising controlling the feeding of a rock drilling machine by means of a pressure difference acting across the rotation motor of a drill rod in such a manner that as rotation resistance increases, after the pressure difference caused by it and acting on the rotation motor exceeds a predetermined threshold value, it brings the spool of a feed control valve controlling the feeding of hydraulic fluid supplied to a feed motor to a position, in which the feed motion is switched to a return motion. The invention also relates to an arrangement for controlling rock drilling, the arrangement comprising a rock drilling machine provided with a percussion apparatus and a rotation motor and a feed motor for pushing the rock drilling machine and a drill rod connected thereto towards material to be drilled and for returning it back, a feed control valve for regulating the feeding of hydraulic fluid to be supplied to the feed motor, a rotation control valve for regulating the feeding of hydraulic fluid to be supplied to the rotation motor, and at least one hydraulic fluid pump for feeding pressurized hydraulic fluid to the percussion apparatus, the rotation motor and the feed motor. The invention further relates to a proportional regulating valve for controlling rock drilling, which valve is controlled by hydraulic fluid pressure and comprises a spool, the spool comprising control pressure surfaces in opposite directions for moving the spool in the valve by means of a pressure difference of the hydraulic fluid acting across a rotation motor, conduits for feeding pressurized hydraulic fluid to the valve and removing substantially non-pressurized hydraulic fluid from the valve, and at least one conduit for leading the hydraulic fluid, the pressure of which is regulated by means of the valve, out of the valve.

In today's rock drilling, a great number of different factors and parameters are taken into account to achieve effective drilling which saves equipment. Also, there are various technologies, which are applied in exceptional cases. These include, for instance, so-called automated fissure methods, wherein pressure of a hydraulic fluid conduit of the rotation motor of a tool is used for controlling the drilling. The starting point in the use of pressure acting on the rotation motor is that as the rotation resistance increases, the risk that the drill bit gets stuck increases. As a result of the increase in the rotation resistance, the pressure rises correspondingly in the hydraulic fluid conduit of the rotation motor, which may be used to express the drilling situation and, on the other hand, to control the drilling operations.

In the prior art, a pressure rise in the hydraulic fluid conduit of the rotation motor is used for controlling the pressure of the hydraulic fluid of feed equipment and, as the pressure of the rotation motor rises, the pressure of the hydraulic fluid to be supplied to the feed equipment is reduced. Furthermore, in the prior art, after the pressure has risen to a predetermined level, the feed equipment is switched to a return motion until the pressure in the hydraulic fluid conduit of the rotation motor decreases. In the prior art, the feed equipment then changes immediately back to a feed motion, and as the drill bit hits the former problem point as a result of the normal feed rate, the rotation resistance and thus the pressure of the hydraulic fluid of the rotation motor increase again, and the feed equipment slows down the feeding and is then possibly switched immediately back to the return motion. This back-and-forth sequence may take place several times in a row. A problem with the known solutions is that as the drilling conditions and hydraulic fluid properties vary, the function and its reliability also change considerably.

### BRIEF DESCRIPTION OF THE INVENTION

It is an object of the present invention to provide a method, arrangement and valve, by which the adjustment may be implemented more reliably and functionally better. The method of the invention is characterized by using the pressure difference acting across the rotation motor to control a separate feed regulating valve, which is arranged to control the feed control valve by means of separate control pressure conduits leading to control pressure surfaces of the spool of the feed control valve in such a manner that as said pressure difference increases but remains below said threshold value, the feed regulating valve regulates pressure values of control pressures controlling the feed control valve according to said pressure difference so that the feed control valve, affected by these control pressures, reduces the flow rate of the hydraulic fluid to be supplied to the feed motor correspondingly. The arrangement of the invention is characterized in that the feed control valve is a flow regulating valve controlled by a pressure difference, that the pressure difference acting across the rotation motor in the hydraulic fluid conduits of the rotation motor is connected to control the feed control valve in such a manner that as the pressure difference increases, the feed control valve reduces the flow of the hydraulic fluid to the feed motor and after the pressure difference exceeds a predetermined threshold value, it switches the hydraulic fluid flow to the feed motor to the opposite direction so that the feed motor is switched to a return motion. The valve of the invention is characterized in that the valve comprises a retarding element, which allows the spool to move freely when the spool is moving in one direction, but slows down the spool movement when the spool tends to move in the opposite direction.

The essential idea of the method according to the invention is that the feeding is adjusted by regulating the flow rate of the hydraulic fluid to be supplied to the feed motor by means of a pressure difference acting across the rotation motor in such a manner that as the pressure difference increases, the flow rate of the hydraulic fluid to be supplied to the feed motor is reduced. Further according to an embodiment of the invention, if the feed motor is switched to a return motion as a result of the increase in the pressure difference acting across the rotation motor, the return process of the feeding back to normal feeding is slowed down correspondingly as the pressure difference decreases.

The essential idea of the arrangement according to the invention is that the regulating valve controlled by the pressure difference between inlet and outlet conduits of the rotation motor is connected to control the control pressures of the control valve of the feed motor in such a manner that as the pressure difference increases, the control valve of the feed motor reduces the flow of the hydraulic fluid to be supplied to the feed motor. Further according to an embodiment of the invention, the arrangement comprises retarding means, which, after the feed motor has been switched to a return motion and the pressure difference has decreased enough to switch the feed motor back to a feed motion, slows down the returning of the feed motion back to normal feed motion values. The essential idea of the valve according to the invention is that it comprises retarding means, which slow down the movement of the valve spool to its normal operating position.

### BRIEF DESCRIPTION OF THE DRAWINGS

The invention will be described in greater detail in the attached drawing, which shows an embodiment of the invention schematically.

### DETAILED DESCRIPTION OF EMBODIMENTS OF THE INVENTION

The drawing shows an embodiment of the invention schematically as a hydraulic diagram. It comprises a first hydraulic fluid pump 1, which is a pressure-controlled volume flow pump. The pump 1, which supplies hydraulic fluid to both a percussion apparatus and a feed motor, sucks hydraulic fluid from a hydraulic fluid container 2. From the pump 1, the hydraulic fluid flows along a conduit 3 to a percussion control valve 4 and, during percussion, further via a hydraulic fluid conduit 5 to a percussion apparatus 6. From the percussion apparatus 6, the hydraulic fluid flows back to the hydraulic fluid container 2. The hydraulic fluid flows further from the pump 1 via the conduit 3 to a feed control valve 7, from which it flows via a conduit 8 to a feed motor 9 of feed equipment, further via a conduit 10 back to the feed control valve 7 and through it to the hydraulic fluid container 2. The feed motor may be either a hydraulically operated motor known per se or a hydraulic cylinder known per se. Both of them are collectively referred to as feed motor. The feed control valve 7 is a so-called proportional valve, in which the position of a spool 7a of the valve can be adjusted by means of pressures acting on the pressure surfaces in opposite directions of the valve spool 7a. Accordingly, the hydraulic fluid flow through the valve is proportional to the position of the spool 7a so that when the spool 7a is in the middle position, hydraulic fluid cannot flow, and when the spool 7a deflects from the middle position in either direction, the flow of the hydraulic fluid through the valve increases proportionally to the deflection. Depending on the direction in which the valve spool 7a moves from its middle position, the pressurized hydraulic fluid is, respectively, connected from the conduit 3 to the conduit 8 and the conduit 10 is connected to the hydraulic fluid container 2, or vice versa. The structure and function of such a control valve are generally known as such and obvious to a person skilled in the art, wherefore they need not be explained in greater detail.

In order to control the pump 1, a first control pressure conduit 11 is connected from the hydraulic fluid conduit 5 of the percussion apparatus via a shuttle valve 12 to a control pressure conduit 13 of the pump 1. The conduits 8 and 10 of the feed motor are further connected via a shuttle valve 14 to a second control pressure conduit 15 and further via the shuttle valve 12 to the control pressure conduit 13 of the pump 1. Thus, the highest pressure of the percussion equipment and, correspondingly, of the hydraulic fluid conduits of the feed motor controls the amount of the hydraulic fluid supplied by the pump 1, i.e. the volume flow. Likewise, from the conduits 8 and 10 of the feed motor 9, the one with a higher pressure is able to have an effect through the shuttle valve 14.

The diagram also shows a second hydraulic fluid pump 16, which supplies hydraulic fluid via a conduit 17 to a rotation control valve 18 and further via a hydraulic fluid conduit 19 to a rotation motor 20. From the rotation motor 20, the hydraulic fluid returns along a second hydraulic fluid conduit 21 back to the valve 18 and through it to the hydraulic fluid container 2. Like the feed control valve 7, the rotation control valve 18 is a proportional valve and functions in the similar manner.

To control the rotation and feeding, steering valves 22 and 23 shown in the FIGURE are required. In order for the steering valves and other valves used in hydraulic coupling to function properly, hydraulic fluid with a suitable pressure must be supplied to them. For this purpose, the hydraulic fluid conduit 3 of the pump 1 is here connected by way of example to a separate pressure reducing valve 24 of the pump 1. The pressure reducing valve 24, for its part, is connected in connection with the hydraulic fluid container, and a hydraulic fluid conduit 25 extending from the valve 24 contains hydraulic fluid with a predetermined pressure, which is supplied to both steering valves 22 and 23.

The rotation steering valve 22 is connected by two conduits 25 and 27 to the rotation control valve 18 in such a manner that the conduits are in connection with the opposite control pressure surfaces of a spool 18a of the valve 18. The conduit 26, which guides the rotation in the normal rotation direction, is further connected to act on the percussion control valve 4 in such a manner that after the rotation control pressure exceeds the predetermined pressure value, the percussion apparatus 6 is switched to operate simultaneously with rotation. To achieve a rotation in the opposite direction in a normal situation, a control pressure is switched for the rotation control valve 18 via the conduit 27 to the opposite control pressure surface of the spool 18a of the rotation control valve 18, whereupon the direction of rotation changes. This is used for dismantling drill rods from one another.

The feed steering valve 23, in turn, is connected via conduits 28 and 29 to control the feed control valve 7. For forward feeding, the control pressure is connected via the conduit 28 to a feed regulating valve 30, which is a proportional pressure regulating valve controlled by a pressure difference, and further through it along a conduit 31 to the first control pressure surface of the spool 7a of the feed control valve 7. The spool 7a of the feed control valve 7 moves then proportionally to the pressure and allows, proportionally to it, hydraulic fluid to flow to the feed motor 9 correspondingly. A conduit 32 extends from the second control pressure surface of the feed control valve 7 to a shuttle valve 33, which is connected at its one end to the control conduit 29 for a return motion and at the opposite end of the shuttle valve 33 via a conduit 34 to the feed regulating valve 30. The second conduit of the feed regulating valve 30, in turn, is connected to the hydraulic fluid container 2.

From the conduits 19 and 21 of the rotation motor 20, control conduits 35 and 36, respectively, are connected to act on the opposite control pressure surfaces of a spool 30a of the feed regulating valve 30. The conduits 19 and 21 are further connected to a shuttle valve 37, which in turn is connected to a control pressure conduit 38 of the hydraulic fluid pump 16 of the rotation in such a manner that the highest pressure acting in the conduits 19 and 21 of the rotation motor controls the volume flow of the hydraulic fluid of the pump 16 of the rotation.

In a normal drilling situation, during percussion and rotation, the pressure of the hydraulic fluid can affect, from the feed steering valve 23 via the feed regulating valve 30 and the conduit 31, the first control pressure surface of the spool 7a of the feed control valve 7 and thus set a hydraulic fluid flow corresponding to the normal feed for the feed equipment 9 from the pump 1. Accordingly, a flow amount of normal-pressure hydraulic fluid required for the rotation speed is supplied from the pump 16 via the conduit 17 and via the rotation control valve 18 and the conduit 19 to the rotation motor. Simultaneously, there is a low pressure in the conduit 21 and the pressure of the conduit 19 controls the feeding of the hydraulic fluid of the pump 16 via the shuttle valve 37 and the conduit 38. In this case, the feed regulating valve 30 is in its normal position, the pressure in the conduit 31 is coming from the steering valve 23, and there is a substantially low pressure, nearly a zero pressure in the conduits 34 and 32.

As the rotation resistance increases, the pressure difference across the rotation motor 20 also increases, whereupon the pressure difference acting on the feed regulating valve 30 increases accordingly and moves its spool 30a from the normal position against a spring 30b. In practice, it is preferable that the pressure difference has a certain predetermined threshold value, after the exceeding of which the spool 30a is able to move. For this purpose, the tightness of the spring 30a may be adjusted to set a desired threshold value. As a result of the increase in the pressure difference, the pressure to be supplied to the first control pressure surface of the spool 7a of the feed control valve 7 via the conduit 31 decreases in the corresponding proportion, and the pressure to be supplied to the second, i.e. the opposite control pressure surface of the spool 7a of the feed control valve 7 via the conduit 34, the shuttle valve 33 and the conduit 32 starts to increase in the same proportion. This change in the pressure difference causes that the spool 7a of the feed control valve 7 moves towards the middle position in the corresponding relation, and the flow rate of the hydraulic fluid to be supplied to the feed motor 9 decreases. As a result, the feed rate diminishes correspondingly. If the rotation resistance continues to increase, it causes bigger changes in the position of the spool 30a of the feed regulating valve 30. As a result, the pressure difference between the conduits 31 and 32 decreases further and the spool 7a of the feed control valve 7 moves closer to its middle position. This, for its part, further reduces the flow rate of hydraulic fluid to be supplied to the feed motor 9 and thus slows down the feeding even more.

If the rotation resistance continues to rise further, at some point the spool 30a of the feed regulating valve 30 moves to a position, in which the pressures in the conduits 31 and 32 are almost the same. In this case, the spool 7a of the feed control valve 7 is almost in its middle position and the feeding of the hydraulic fluid to the feed motor 9 is weak, but it takes place, however, in the forward direction. After this, if the rotation resistance increases further, it exceeds a predetermined threshold value and the feed regulating valve 30 switches the control pressures to be supplied to the feed control valve 7 to the opposite, whereupon the spool 7a of the control valve 7 moves in the direction of return motion and the feed motor 9 is switched to a return motion. The afore-mentioned second threshold value, after the exceeding of which the flow of the hydraulic fluid to be supplied to the feed motor is reduced, is smaller than this threshold value crucial between return and feed motions for switching.

If the rotation resistance decreases as a result of the return motion, the pressure in the hydraulic fluid conduit 19 of the rotation motor 20 decreases correspondingly and the pressure difference between the conduits 19 and 21 diminishes. As a consequence, the spool 30a of the feed regulating valve 30 can return back towards its normal position, allowing, after the pressure difference has decreased again below the threshold value, the control pressures acting on the feed control valve 7 to be in accordance with the normal feeding, and the feed motor 9 is, controlled by the control valve 7, switched to a normal feed motion.

In this case, if the feed motion would immediately be switched to a forward feed motion with a normal speed, a back-and-forth pendulum motion could be generated in accordance with the prior art, as the rotation resistance suddenly increases and then decreases. To reduce this, a retarding element 39 is connected to the operation of the spool 30a of the feed regulating valve 30. The retarding element comprises a piston 40, which moves in a cylinder 41. Both sides of the piston 40 are affected by the pressure of the conduit 19 of the rotation motor. Further on the other side of the piston 40 there is a spring 42, which tends to push the piston 40 towards the spool 30a of the feed regulating valve 30. The piston 40 further comprises a check valve 43, through which the hydraulic fluid is able to flow freely from the side of the spool 30a of the regulating valve 30 to the opposite side, i.e. the side of the spring 42, of the piston 40. Instead of the piston, the check valve 43 may naturally also be located elsewhere, such as in a conduit connecting the spaces on the opposite sides of the piston 40 of the cylinder 41. When the spool of the regulating valve 30 is in its normal position, the piston 40 is pushed against the spring 42 under the influence of the spool. As the pressure difference acting across the rotation motor 30 increases, the spool of the regulating valve 30 moves away from the piston 40, which, pushed by the spring 42, follows the spool to a predetermined position, i.e. at least nearly to the minimum value of the feeding, and remains there as long as the spool 30a of the regulating valve 30 is in this position under the influence of the pressure difference caused by the high rotation resistance. The spool 30a may further move a distance from the extreme position of the piston 40 in the same direction in order to change the feed direction. As the pressure decreases as a result of the decrease in the rotation resistance, the spool 30a of the regulating valve 30 returns back towards the piston 40. As the spool 30a hits the piston 40 and starts to push the piston 40 towards the spring 42, the hydraulic fluid may exit the space on the side of its spring only through a choke 44, whereupon, regardless of the pressures acting on the regulating valve 30 in the conduits 35 and 36, the spool 30a of the regulating valve 30 is able to move towards its normal position with a delay that can be adjusted by changing or adjusting the size of the choke 44. At the same time, the feed rate increases with a delay and not suddenly.

The invention is described above in the specification and the drawing by way of example only, and it is not restricted thereto in any way. It is essential that the operation of the feed motor of the rock drilling equipment is controlled on the basis of the pressure difference acting across the rotation motor in such a manner that by means of a separate regulating valve, control pressures of the feed control valve and thus the flow rate of the hydraulic fluid to be supplied to the feed motor are controlled proportionally to the rotation resistance, and when the pressure difference exceeds a predetermined value, the feed motion is switched to a return motion. Even though the diagram shows separate hydraulic fluid pumps 1, 16 for each function and also several hydraulic fluid containers 2, it is common in practice that the hydraulic fluid required for all these functions can be supplied from one common hydraulic fluid pump, and the hydraulic fluid container 2 is usually also common to all pumps and actuators. In practice, it is naturally also possible to use different hydraulic fluid pumps for different hydraulic connections as shown in the diagram or in some other known manner.

1. A method for controlling rock drilling, the method comprising controlling the feeding of a rock drilling machine by means of a pressure difference acting across the rotation motor of a drill rod in such a manner that as rotation resistance increases, after the pressure difference caused by it and acting on the rotation motor exceeds a predetermined threshold value, it brings the spool of a feed control valve controlling the feeding of hydraulic fluid supplied to a feed motor to a position, in which the feed motion is switched to a return motion, wherein
the pressure difference acting across the rotation motor is used to control a separate feed regulating valve, which is arranged to control the feed control valve by means of separate control pressure conduits leading to control pressure surfaces of the spool of the feed control valve in such a manner that as said pressure difference increases but remains below said threshold value, the feed regulating valve regulates pressure values of control pressures controlling the feed control valve according to said pressure difference so that the feed control valve, affected by these control pressures, reduces the flow rate of the hydraulic fluid to be supplied to the feed motor correspondingly.

2. A method as claimed in claim 1, wherein
the pressure difference acting across the rotation motor is used to start to control said feed regulating valve after the pressure difference exceeds a second threshold value which is smaller than said threshold value.

3. A method as claimed in claim 2, wherein
when the pressure difference caused by the rotation resistance and acting across the rotation motor is below said threshold value again and the feed motor is, controlled by the feed control valve, switched back to a feed motion, the increase in the speed of feed motion is slowed down by slowing down the change of the control pressures of the feed control valve with respect to their normal operating values.

4. An arrangement for controlling rock drilling, the arrangement comprising a rock drilling machine provided with a percussion apparatus and a rotation motor and a feed motor for pushing the rock drilling machine and a drill rod connected thereto towards material to be drilled and for returning it back, a feed control valve for regulating the feeding of hydraulic fluid to be supplied to the feed motor, a rotation control valve for regulating the feeding of hydraulic fluid to be supplied to the rotation motor, and at least one hydraulic fluid pump for feeding pressurized hydraulic fluid to the percussion apparatus, the rotation motor and the feed motor, wherein
the feed control valve is a flow regulating valve controlled by a pressure difference, that
the pressure difference acting across the rotation motor in the hydraulic fluid conduits of the rotation motor is connected to control the feed control valve in such a manner that as the pressure difference increases, the feed control valve reduces the flow of the hydraulic fluid to the feed motor and after the pressure difference exceeds a predetermined threshold value, it switches the hydraulic fluid flow to the feed motor to the opposite so that the feed motor is switched to a return motion.

5. An arrangement as claimed in claim 4, wherein
the arrangement comprises a proportional pressure regulating valve controlled by the pressure difference, to which a hydraulic fluid conduit extends and from which a conduit extends to a hydraulic fluid container, that
two control pressure conduits extend from the feed regulating valve to the feed control valve, and that under the influence of the pressure difference acting on the regulating valve, the pressures of the control pressure conduits are set in such a manner that when the pressure difference is below the predetermined threshold value, the pressure of the first control conduit is substantially the pressure of the hydraulic fluid to be supplied to the regulating valve and, respectively, the pressure of the second control conduit is substantially the pressure of the hydraulic fluid container,
that as the pressure difference increases, the pressure of the first control pressure conduit decreases proportionally to the increase in the pressure difference and, respectively, the pressure of the second control pressure conduit increases correspondingly,
whereby the change in the pressure differences controls the feed control valve accordingly, causing a decrease in the flow rate of the hydraulic fluid to be supplied to the feed motor,
that as the pressure difference acting across the rotation motor reaches the predetermined threshold value, there is a small pressure difference in the control pressure conduits, wherefore the flow of the hydraulic fluid to the feed motor is at its minimum, and if the pressure difference increases further, the pressure of the first control pressure conduit approaches the pressure value of the hydraulic fluid container and the pressure of the second control pressure conduit approaches the pressure value of the hydraulic fluid to be supplied to the regulating valve, whereupon the flow direction of the hydraulic fluid to be supplied to the feed motor changes and the feed motor is switched to a return motion.

6. An arrangement as claimed in claim 5, wherein the feed regulating valve comprises
a retarding element, which, after the rotation resistance has decreased and thus the pressure difference acting across the rotation motor has decreased, slows down the returning of the spool of the regulating valve to its normal operating position, whereupon the change in the pressures of the control pressure conduits extending from the regulating valve with respect to their normal pressure values slows down, thus controlling the feed control valve in such a manner that the increase in the rate of hydraulic fluid flow to the feed motor takes place with a delay.

7. A proportional regulating valve for controlling rock drilling, which valve is controlled by hydraulic fluid pressure and comprises a spool, the spool comprising control pressure surfaces in opposite directions for moving the spool in the valve by means of a pressure difference of the hydraulic fluid acting across a rotation motor, conduits for feeding pressurized hydraulic fluid to the valve and removing substantially non-pressurized hydraulic fluid from the valve, and at least one conduit for leading the hydraulic fluid, the pressure of which is regulated by means of the valve, out of the valve, wherein
the valve comprises a retarding element, which allows the spool to move freely when the spool is moving in one direction, but slows down the spool movement when the spool tends to move in the opposite direction.

8. A valve as claimed in claim 7, wherein the retarding element comprises
a piston which moves in a cylinder space and is affected by a spring on the opposite side of the spool,
a check valve, which is connected to allow the flow of the hydraulic fluid in the cylinder space from the part on the side of the spool to the part on the side of the spring substantially without resistance but to prevent the flow over the same route back, and
a choke, through which the cylinder space on the side of the spring is connected in connection with the cylinder space on the side of the spool so that the flow of the hydraulic fluid causes a delay.
